(19) United States
(12) Patent Application Publication
(10) Pub. No.: US 2009/0248264 A1
(43) Pub. Date: Oct. 1, 2009

(54) CONTROL APPARATUS FOR AUTOMATIC TRANSMISSION

(75) Inventor: Takayuki KUBO, Anjo-shi (JP)

Correspondence Address: BACON & THOMAS, PLLC, 625 SLATERS LANE, FOURTH FLOOR, ALEXANDRIA, VA, 22314-1176, US

(73) Assignee: AISIN AW CO., LTD., Anjo-shi (JP)

(21) Appl. No.: 12/397,966

(22) Filed: Mar. 4, 2009

(30) Foreign Application Priority Data
Mar. 28, 2008 (JP) 2008-085344

(51) Int. Cl. F16H 59/16; G06F 17/00

(52) U.S. Cl. 701/58; 477/143

(57) ABSTRACT

Strain gauges and a torque value calculating unit detect a torque value acting on a sun gear based on a reaction force. An input equivalent value calculating unit calculates an input torque equivalent value based on the detected torque value, and a hydraulic pressure control unit controls output from a starting clutch by controlling operation of a hydraulic servo, based on the input torque equivalent value calculated by the input equivalent value calculating unit. Therefore, by measuring the input torque equivalent value derived from a value for torque acting on the fixed sun gear in an automatic speed change mechanism and then monitoring the input torque equivalent value as a target input torque, the control unit precisely controls the hydraulic pressure to the starting clutch FB control.

### INCORPORATION BY REFERENCE

The disclosure of Japanese Patent Application No. 2008-085344 filed on Mar. 28, 2008, including the specification, drawings and abstract is incorporated herein by reference in its entirety.

### BACKGROUND OF THE INVENTION

1. Field of the Invention

The present invention relates to a control apparatus for an automatic transmission mounted on a vehicle such as an automobile, and particularly to a control apparatus for an automatic transmission provided with a starting clutch.

2. Description of the Related Art

In general, an automatic transmission, regardless of whether it is a stepped or a stepless type, receives rotation of the engine through a torque converter. Because the torque converter transmits power through a fluid, between input and output elements, it provides smooth power transmission, but on the other hand, fuel consumption efficiency is reduced by slip between the input and output elements. Therefore, an automatic clutch control device has been proposed for use in conjunction with a starting clutch, instead of a torque converter, whereby the engine rotation would be transferred to an automatic speed change mechanism through the starting clutch so that the efficiency can be increased and fuel consumption can be reduced (refer, for example, to Japanese Patent Application Publication No. JP-A-2002-31166).

When the starting clutch is initially engaged, the automatic clutch control device provides control based on detected engine speed and clutch piston stroke. More specifically, the automatic clutch control device is provided with an engine rotary state detecting device that detects the rotary state of the engine, a clutch stroke detecting device that detects the stroke of the starting clutch, a clutch actuator that drives the starting clutch for engagement and disengagement, and a control device that detects a creep point at which the vehicle starts creeping motion, based on the engine rotary state detected by the engine rotary state detecting device and the clutch stroke detected by the clutch stroke detecting device, and controls the clutch actuator so as to maintain the clutch stroke when judging that the vehicle has reached the creep point. With the structure described above, it is possible to provide controlled creep (very low speed running by transmission of a small amount of engine torque) in which a necessary amount of creep force is provided while preventing generation of vibration and noise due to control hunting during the creeping.

### SUMMARY OF THE INVENTION

In a device, such as the automatic clutch control device that has a starting clutch instead of a torque converter, it is necessary to maintain a small amount of rotational slip in generating the creep force. However, because conventional input rotation sensors detect an input rotational speed as 0 when the vehicle is in a stationary state, it is difficult to detect a rotational speed that can serve as a target for feedback control (hereinafter also referred to as FB control), and therefore it is extremely difficult to perform the FB control.

If, to facilitate FB control the rotation sensor is installed immediately downstream of the starting clutch, thereby improving the accuracy, even with supply of a certain level of hydraulic pressure, there is nothing to be monitored. Hence, it has been difficult to maintain a torque at a uniform level with only a relative rotational speed, dependent on oil temperature change, engine speed change and/or engine output change.

Therefore, it is an object of the present invention to provide a control apparatus for an automatic transmission that is capable of achieving a smooth vehicle start by measuring an input torque equivalent value using a fixed gear in a speed change mechanism and precisely controlling the starting clutch based on the input torque equivalent value to generate a desired output when starting the vehicle.

According to one aspect of the present invention, there is provided a control apparatus for an automatic transmission that includes: a speed change mechanism that introduces rotation of a driving source into an input shaft through a starting clutch that is disconnected and connected by a hydraulic servo; a fixed gear, provided in the speed change mechanism, that is fixed to a transmission case and generates a reaction force against the rotation of the input shaft; a fixed gear torque detecting unit that detects, based on the reaction force, a torque value acting on the fixed gear; an input equivalent value calculating unit that calculates an input torque equivalent value based on the detected torque value; and a starting control unit that controls output from the starting clutch by controlling operation of the hydraulic servo, based on the input torque equivalent value calculated by the input equivalent value calculating unit.

The fixed gear torque detecting unit detects the torque value acting on the fixed gear based on the reaction force, the input equivalent value calculating unit calculates the input torque equivalent value based on the detected torque value, and the starting control unit controls the output from the starting clutch by controlling operation of the hydraulic servo, based on the input torque equivalent value calculated by the input equivalent value calculating unit. Therefore, by measuring the input torque equivalent value using a fixed gear in the speed change mechanism and monitoring the input torque equivalent value as an input target torque, it becomes possible to precisely control the hydraulic pressure to the starting clutch with FB control.

The control apparatus of the invention may further include a learning control unit that applies learning correction to a learning value obtained in a control cycle performed by the starting control unit and uses that corrected value in the next control cycle. Therefore, variation in output in the successive control cycles can be reduced to provide better control.

Further, according to an aspect of the present invention, the starting control unit supplies a hydraulic pressure based on a command value for pressure supplied to the hydraulic servo. The learning control unit calculates a learning value that is calculated from a target rotational speed difference and an actual rotational speed difference, and adds the learning value to the command value. Therefore, it is possible to precisely control supply of hydraulic pressure to the starting clutch with FB control.

Thus, according to one aspect of the present invention, the fixed gear torque detecting unit is composed of a strain detecting sensor that detects strain on the fixed gear caused by the torque acting from the input shaft side and a torque value calculating unit that calculates the torque value acting on the fixed gear, based on the strain detected by the strain detecting sensor.

The fixed gear torque detecting unit is composed of the strain detecting sensor that detects strain on the fixed gear caused by the torque acting from the input shaft side, and the torque value calculating unit that calculates the torque value acting on the fixed gear, based on the strain detected by the strain detecting sensor. Therefore, because, for example, a strain gauge of a simple structure and comparatively low cost can be used as the strain detecting sensor, and a structure for easily detecting the strain on the fixed gear is easily detected by, for example, directly adhering the strain gauge to the fixed gear, it is possible to determine a torque value for use in creep control with an extremely simple structure.

The present invention may be applied to a speed change mechanism including: a decelerating planetary gear set that decelerates rotation input as the rotation of the input shaft; a planetary gear unit that has four rotary elements including an output element connected to an output shaft of the speed change mechanism; two decelerating clutches that selectively transmit rotation of the decelerating planetary gear set, respectively, to two of the rotary elements of the planetary gear unit; and an input clutch that, upon engagement, transfers rotation of the input shaft to one of the rotary elements of the planetary gear unit, thereby achieving five or six forward speeds. The fixed gear is a gear that is constantly held stationary in the decelerating planetary gear set. Therefore, by using a comparatively simple structure in which merely a strain detecting sensor or the like is attached to the fixed gear, i.e. a gear fixed to the transmission case, five or six forward speeds can be provided and the change in the input torque can be accurately detected in a direct manner and used for creep control.

In a preferred embodiment, the decelerating planetary gear set is composed of a sun gear (fixed gear) that is fixed to the transmission case, a ring gear that outputs the decelerated rotation, and a carrier that receives the rotation of the input shaft. Therefore, by using a comparatively simple structure in which merely a strain detecting sensor or the like is attached to the sun gear fixed to the transmission case, the input torque can be detected early and accurately, and used for creep control.

### BRIEF DESCRIPTION OF THE DRAWINGS

FIG. 1 is a block diagram of a control apparatus for an automatic transmission according to the present invention;

FIG. 2 is a skeletal diagram of an automatic speed change mechanism to which the present invention can be applied;

FIG. 3 is a shift table for the automatic speed change mechanism, showing states of engagement of the various frictional engagement elements;

FIG. 4 is a velocity diagram for the automatic speed change mechanism;

FIG. 5 is a schematic diagram of a stationary sun gear in a planetary gear set in the automatic speed change mechanism, showing strain gauges fixed to the sun gear;

FIG. 6 is a schematic diagram of a hydraulic circuit in a hydraulic control device according to the present invention;

FIG. 7A and FIG. 7B are time charts for the operation of the control apparatus of the present invention;

FIG. 8 is another time chart for the operation of the control apparatus of the present invention;

FIG. 9 is another time chart for the operation of the control apparatus of the present invention; and

FIG. 10 is a flow chart of operation of the control apparatus of the present invention.

### DESCRIPTION OF PREFERRED EMBODIMENTS

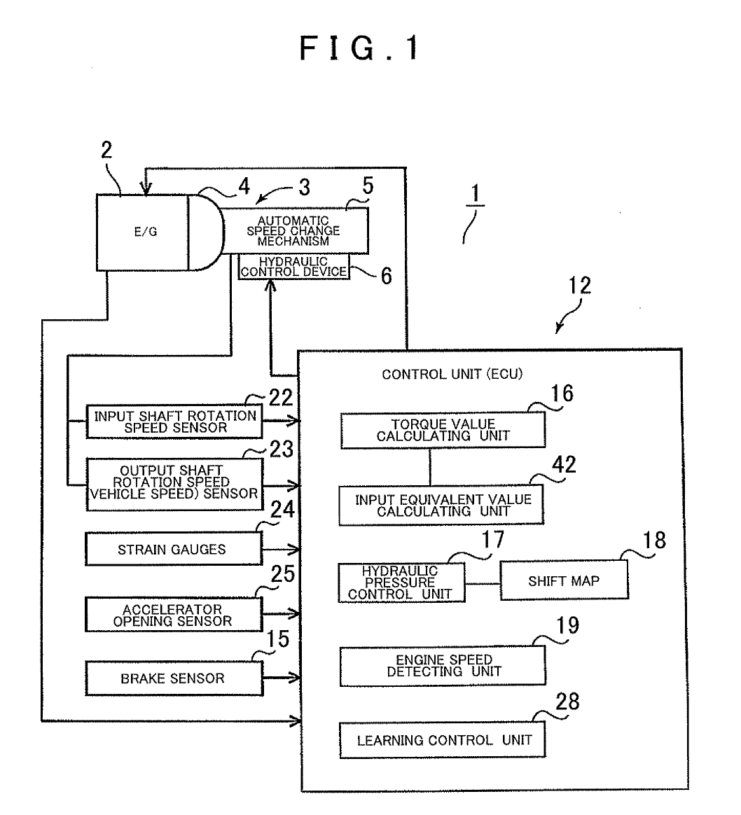

A preferred embodiment of the present invention is described below with reference to FIGS. 1 to 10.

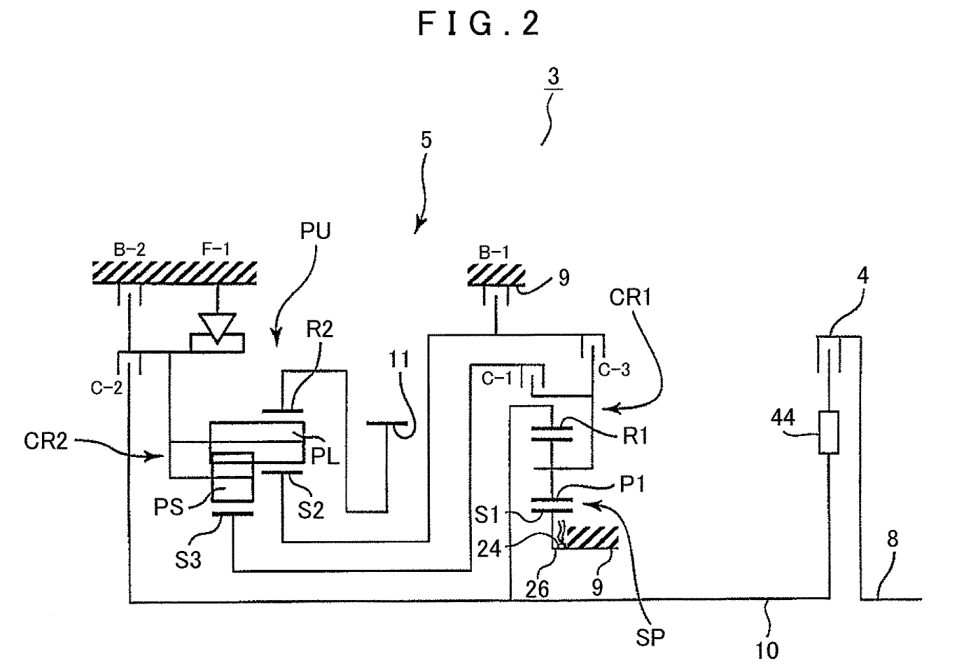

First, the structure of an automatic transmission 3 to which the present invention can be applied will be described with reference to FIG. 2. As shown in FIG. 2, the automatic transmission 3 that is suitable for use in, for example, an FF (front engine, front drive) type vehicle, has an input shaft 8 connected to an engine 2 (refer to FIG. 1) serving as a driving source. The automatic transmission 3 includes a starting clutch 4 and an automatic speed change mechanism (speed change mechanism) 5, both of which are centered on and aligned along the axis of the input shaft 8. A transmission case 9 houses the automatic speed change mechanism 5.

The automatic transmission 3 is a stepped automatic transmission that has clutches C-1, C-2, and C-3, and brakes B-1 and B-2 serving as friction engagement elements whose engagement states establish one of a plurality of corresponding power transmission paths through the automatic speed change mechanism 5. Six different forward speeds are achieved by switching engagement among those engagement elements. However, the present invention can be applied, not only to an automatic transmission providing six forward speeds, but also to an automatic transmission having five forward speeds, etc.

When the starting clutch 4 is engaged under hydraulic control of a hydraulic control device 6 (refer to FIG. 1), the rotation of the input shaft 8 of the automatic transmission 3 is directly transmitted to the input shaft 10 of the automatic speed change mechanism 5. The hydraulic control device 6 is provided with multiple hydraulic servos (not shown) for operation of the automatic speed change mechanism 5, as well as multiple shift valves for switching hydraulic pressure to these hydraulic servos.

The automatic speed change mechanism 5 is provided with a planetary gear set SP and a planetary gear unit PU on the input shaft 10. The planetary gear SP is a single pinion planetary gear set that is provided with a sun gear (fixed gear) S1, a carrier CR1, and a ring gear R1, the carrier CR1 having a pinion P1 that meshes with the sun gear S1 and the ring gear R1. The sun gear S1 is a gear that is constantly held stationary in the planetary gear set SP. The planetary gear set SP is a decelerating planetary gear set that outputs rotation that is decelerated from the rotational speed of the input shaft 10.

The planetary gear unit PU is a so-called Ravigneaux type planetary gear set that has four rotary elements, i.e. sun gear S2, a sun gear S3, a carrier CR2, and a ring gear R2. The carrier CR2 has a long pinion PL that meshes with the sun gear S2 and the ring gear R2, and a short pinion PS that meshes with the sun gear S3. The clutches C-3 and C-1 are each decelerating clutches that transmit rotation of the planetary gear set SP to the sun gears S2 and S3, respectively. The clutch C-2 is an input clutch that transmits rotation of the input shaft 10 to the carrier CR2 which is one of the rotary elements of the planetary gear unit PU. The ring gear R2 serves an output element connected to an output shaft (not shown) of the automatic speed change mechanism 5.

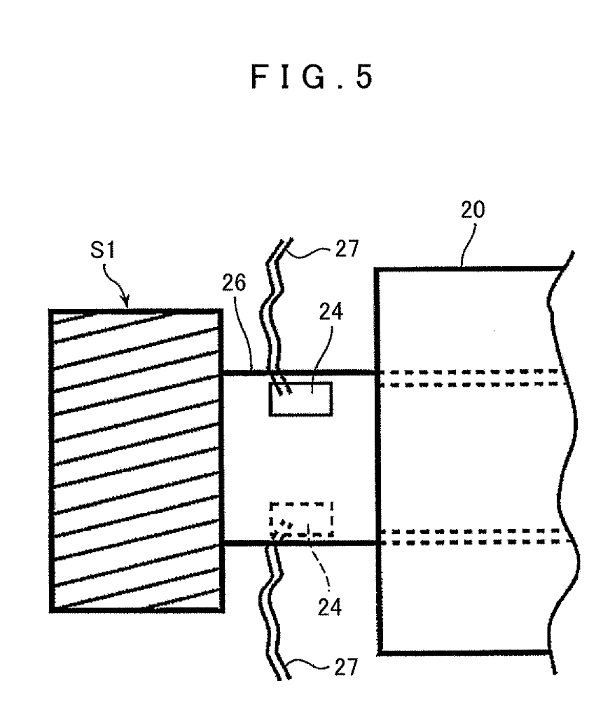

As shown in FIGS. 2 and 5, the sun gear S1 of the planetary gear set SP is fixed to the transmission case 9 to generate a reaction force against the rotation of the input shaft 10. More specifically, the sun gear S1 is a fixed by connection through a spline connection to a boss 20 fixed as a unit to the transmission case 9 and thereby constantly held stationary. A shaft portion 26 of the sun gear S1 is connected to the boss 20 on the transmission case 9 and a strain gauge 24, that detects strain of the sun gear S1 (that is, the shaft portion 26) corresponding to the torque from the input shaft 10 side, is directly fixed to the shaft portion 26 by adhesive or the like. The strain gauge 24 is a strain detecting sensor for detecting the strain between the sun gear S1 and the transmission case 9 caused by the torque acting from the input shaft 10 side.

Two strain gauges 24 are fixed to opposing sides of the shaft portion 26. Thus, the strain is detected by two strain gauges fixed to the outer circumferential surface of the shaft portion 26. The strain gauges 24 are connected to a control unit 12 through electrical connection cables 27. Note that the number of the strain gauges 24 is not limited to two and strain gauges 24 can also be fixed at three or four positions on the outer circumferential surface of the shaft portion 26 at even angular intervals.

As shown in FIG. 2, the ring gear R1 has the same rotation as the rotation of the input shaft 10 (hereinafter called “input rotation”). Moreover, the carrier CR1 rotates at a decelerated rotation that is decelerated from the input rotation of the ring gear R1 and the carrier CR1 is connected to the clutch C-1 and the clutch C-3.

The sun gear S2 of the planetary gear unit PU can be fixed to the transmission case 9 by engagement of the brake (engagement element) B-1, and can also be connected through the clutch C-3 to receive the decelerated rotation input from the carrier CR1. In addition, the sun gear S3 can be connected through the clutch C-1 to receive the decelerated rotation input from the carrier CR1.

The carrier CR2 is connected through the clutch C-2 to receive the rotation input from the input shaft 10. The carrier CR2 is also connected to a one-way clutch (engagement element) F-1 and thereby restricted to rotation in one direction relative to the transmission case 9 and can be held stationary through engagement of the brake B-2. Furthermore, the ring gear R2 is connected to a counter gear 11, and the counter gear 11 is connected to drive wheels (not shown) through a counter shaft (not shown) and a differential device (not shown).

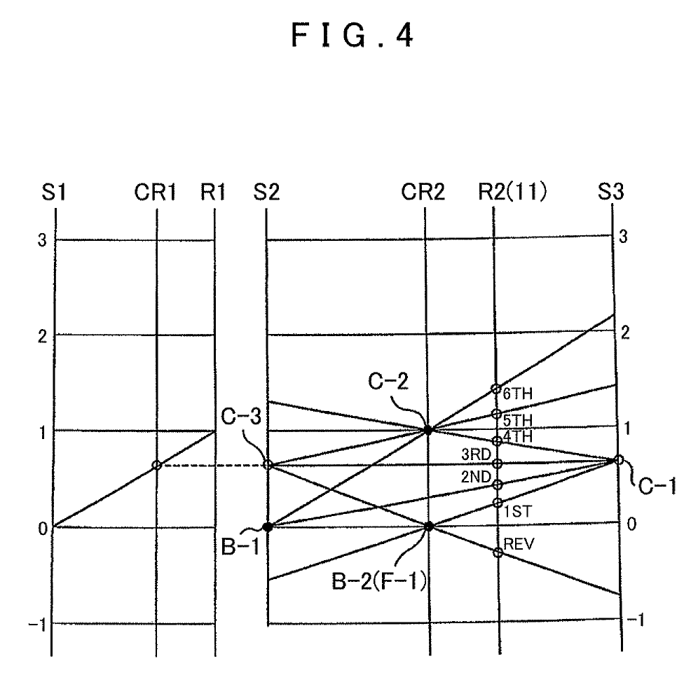

Next, the operation of the automatic speed change mechanism 5 will be described with reference to FIGS. 2, 3, and 4. Note that, in the velocity diagram shown in FIG. 4, each vertical axis represents the rotational speed of a corresponding rotary element (gear), and the horizontal axis represents the gear ratios of those rotary elements. In the section of the planetary gear set SP in the velocity diagram, the vertical axes correspond respectively to the sun gear S1, the carrier CR1, and the ring gear R1, in that order from the left in FIG. 4. In the section of the planetary gear unit PU in the velocity diagram, the vertical axes correspond respectively to the sun gear S3, the ring gear R2, the carrier CR2, and the sun gear S2, in that order from the right in FIG. 4.

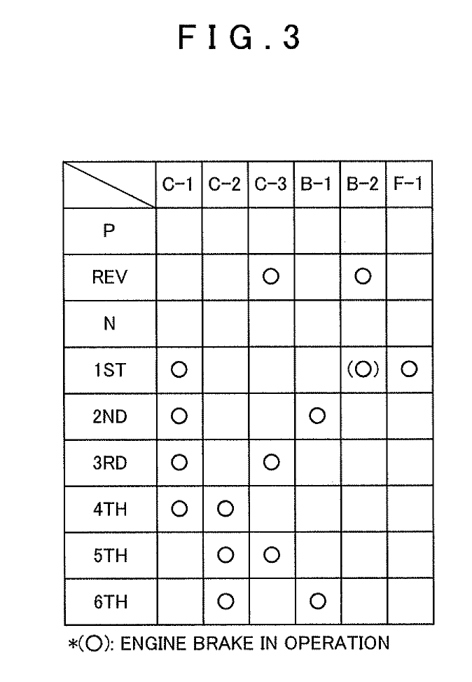

For example, in the first forward speed (1ST) in the D (drive) range, the clutch C-1 and the one-way clutch F-1 are engaged, as shown in FIG. 3. Then, as shown in FIGS. 2 and 4, the rotation of the carrier CR1, which is decelerated by the fixed sun gear S1 and the ring gear R1, is introduced to the sun gear S3 through the clutch C-1. In addition, the rotation of the carrier CR2 is restricted to rotation in one direction (forward rotary direction); that is, the carrier CR2 is prevented from rotation in the reverse direction and is held in the fixed state. Then, the decelerated rotation introduced to the sun gear S3 is output to the ring gear R2 through the fixed carrier CR2. Thus, the forward rotation as the first forward speed is output from the counter gear 11.

Note that, during engine braking (coasting), the above-described state of the first forward speed is maintained with the brake B-2 locked to fix the carrier CR2 so that the carrier CR2 is prevented from rotating forward. Moreover, because the carrier CR2 is prevented from rotating in the reverse direction and allowed to rotate forward by the one-way clutch F-1 in the first forward speed, the first forward speed can be achieved more smoothly by automatic engagement of the one-way clutch F-1, in the case, for example, of a shift from a non-drive range to a drive range.

In the second forward speed (2ND), the clutch C-1 is engaged and the brake B-1 is locked, as shown in FIG. 3. Then, as shown in FIGS. 2 and 4, the rotation of the carrier CR1, which rotates at a speed that is decelerated by the fixed sun gear S1 and the ring gear R1, is introduced to the sun gear S3 through the clutch C-1. The sun gear S2 is held stationary by engagement of the brake B-1. Then, the carrier CR2 rotates at a decelerated rotation, slower than that of the sun gear S3, and the decelerated rotation introduced to the sun gear S3 is output to the ring gear R2 through the carrier CR2. Thus, the forward rotation as the second forward speed is output from the counter gear 11.

If the clutch C-1 is released while in the second forward speed, to establish a slipping state by neutral control, the ring gear R2 is allowed to rotate forward and prevented from rotating in reverse by the one-way clutch F-1, thus preventing reverse rotation of the carrier CR2. Thus, a state of so-called hill holding is achieved, in which the reverse motion of the vehicle (reverse rotation of drive wheels) is prevented.

In the third forward speed (3RD), the clutch C-1 and the clutch C-3 are engaged, as shown in FIG. 3. Then, as shown in FIGS. 2 and 4, the rotation of the carrier CR1, which is rotated by the ring gear R1 in cooperation with the fixed sun gear S1, at a speed that is decelerated from the speed of the input rotation of the ring gear R1, is introduced to the sun gear S3 through the clutch C-1. In addition, the decelerated rotation of the carrier CR1 is introduced to the sun gear S2 by engagement of the clutch C-3. Because, the decelerated rotation of the carrier CR1 is introduced to the sun gear S2 and the sun gear S3, the planetary gear unit PU rotates at the decelerated speed in a directly connected state, and the decelerated rotation is directly output to the ring gear R2. Thus, the forward rotation as the third forward speed is output from the counter gear 11.

In the fourth forward speed (4TH), the clutch C-1 and the clutch C-2 are engaged, as shown in FIG. 3. As shown in FIGS. 2 and 4, the rotation of the carrier CR1, which rotates at the decelerated speed, is introduced to the sun gear S3 through the clutch C-1. In addition, the input rotation is introduced to the carrier CR2 by the engagement of the clutch C-2. Then, a decelerated rotation faster than that of the third forward speed is produced by the sun gear S3 and the input rotation introduced to the carrier CR2, and is output to the ring gear R2. Thus, the forward rotation as the fourth forward speed is output from the counter gear 11.

In the fifth forward speed (5TH), the clutch C-2 and the clutch C-3 are engaged, as shown in FIG. 3. Then, as shown in FIGS. 2 and 4, the rotation of the carrier CR1, which rotates at the decelerated speed, is introduced to the sun gear S2 through the clutch C-3. In addition, the input rotation is introduced to the carrier CR2 by the engagement of the clutch C-2. Then, an accelerated rotation slightly faster than the input rotation is produced by the decelerated rotation introduced to the sun gear S2 and the input rotation introduced to the carrier CR2, and is output to the ring gear R2. Thus, the forward rotation as the fifth forward speed is output from the counter gear 11.

In the sixth forward speed (6TH), the clutch C-2 is engaged and the brake B-1 is locked, as shown in FIG. 3. Then, as shown in FIGS. 2 and 4, the input rotation is introduced to the carrier CR2 by the engagement of the clutch C-2. In addition, the sun gear S2 is held stationary by the locking of the brake B-1 whereby the input rotation of the carrier CR2 is accelerated to a speed faster than that of the fifth forward speed by the fixed sun gear S2, and is output to the ring gear R2. Thus, the forward rotation as the sixth forward speed is output from the counter gear 11.

In the first reverse speed (REV), the clutch C-3 is engaged and the brake B-2 is locked, as shown in FIG. 3. Then, as shown in FIGS. 2 and 4, the rotation of the carrier CR1, which rotates at the decelerated speed, is introduced to the sun gear S2 through the clutch C-3. In addition, the carrier CR2 is held stationary (without rotation) by the locking of the brake B-2 whereby the decelerated rotation introduced to the sun gear S2 is output to the ring gear R2 through the fixed carrier CR2. Thus, the reverse rotation as the first reverse speed is output from the counter gear 11.

Note that, in the P (parking) range and in the N (neutral) range (non-driving ranges), the clutches C-1, C-2, and C-3 are disengaged. Thus, the carrier CR1 is disconnected from the sun gears S2 and S3, that is, the planetary gear set SP is disconnected from the planetary gear unit PU, and also the input shaft 10 and the carrier CR2 are disconnected from each other. Consequently, power transmission is disconnected between the input shaft 10 and the planetary gear unit PU, that is, between the input shaft 10 and the counter gear 11.

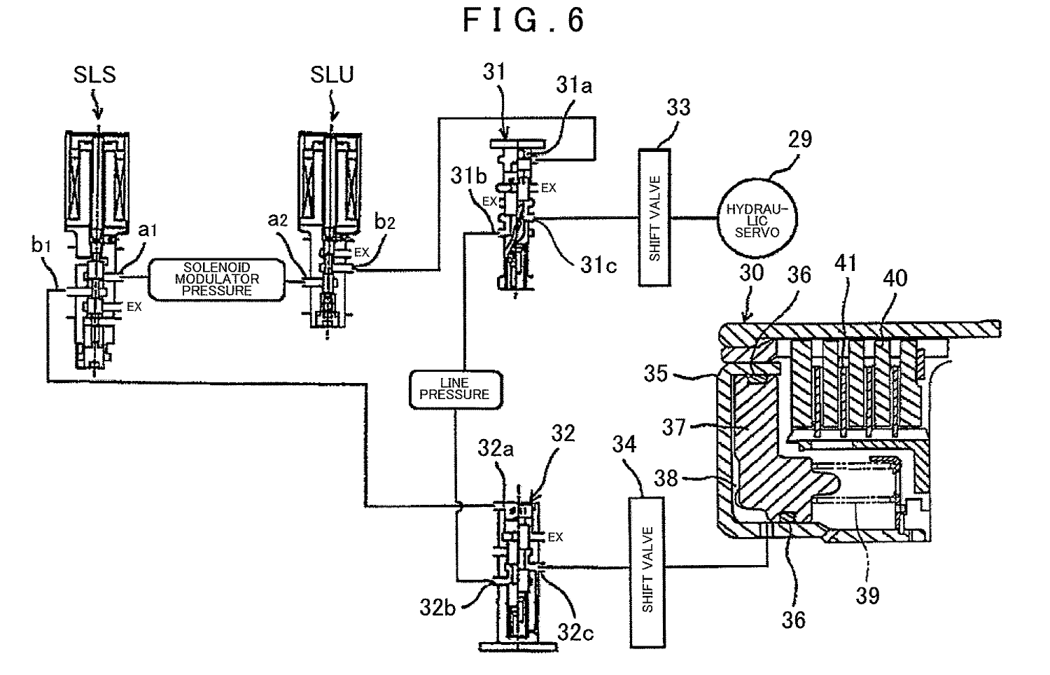

Next, the hydraulic circuit in the hydraulic control device 6 will be described with reference to FIG. 6. The hydraulic circuit has two linear solenoid valves SLS and SLU, and also has a plurality of hydraulic servos 29 and 30 that disconnect and connect the plurality of friction engagement elements for achieving, for example, six forward speeds and one reverse speed by switching the power transmission path through the automatic speed change mechanism. A solenoid modulator pressure is supplied to input ports a₁ and a₂ of the linear solenoid valves SLS and SLU, respectively, and hydraulic control pressures from output ports b₁ and b₂ of the corresponding linear solenoid valves are supplied to fluid control chambers 31a and 32a of corresponding pressure control valves 31 and 32, respectively. The pressure control valves 31 and 32 are supplied with a line pressure through input ports 31b and 32b, respectively, and regulated pressures, that are regulated by the control hydraulic pressures, are supplied from output ports 31c and 32c through shift valves 33 and 34 to the hydraulic servos 29 and 30, respectively, as appropriate.

Note that hydraulic circuit shown in FIG. 6 is intended merely to show a basic concept, and thus the hydraulic servos 29, 30 and the shift valves 33, 34 are only representative of the large number of hydraulic servos provided for control of the automatic speed change mechanism 5, and the large number of shift valves for switching hydraulic pressures to the hydraulic servos. As illustrated for hydraulic servo 30, each hydraulic servo has a piston 37 that is fit in a cylinder 35 in an oil-tight manner with oil seals 36. Based on the regulated hydraulic pressure from the pressure control valve 32 that acts in a hydraulic pressure chamber 38, the piston 37 moves against a return spring 39 to make outer friction plates 40 contact inner friction materials 41 thereby engaging clutch 30. Although the friction plates and the friction materials are shown as a clutch 30, this hydraulic control circuit is also applicable to operation of a brake.

Next, a control apparatus 1 for the automatic transmission according to the present invention will be described with reference to FIG. 1. As shown in FIG. 1, the control apparatus 1 for the automatic transmission includes a control unit (ECU) 12 that receives a signal from the engine (E/G) 2, signals from an input shaft rotational speed sensor 22 and an output shaft rotational speed (vehicle speed) sensor 23 of the automatic transmission 3 (automatic speed change mechanism 5), a signal from the strain gauges 24, a signal from an accelerator opening sensor 25, and a signal from a brake sensor 15. The input shaft rotational speed sensor 22 detects the rotational speed of the input shaft 10, and the output shaft rotational speed sensor 23 detects the rotational speed of the output shaft (not shown) downstream of the counter gear 11.

The control unit 12 includes a torque value calculating unit 16, an input equivalent value calculating unit 42, a hydraulic pressure control unit (a starting control unit) 17, a shift map 18, an engine speed detecting unit 19, and a learning control unit 28. The combination of the torque value calculating unit 16 and the strain gauges 24 forms a fixed gear torque detecting unit that detects a torque value for torque acting on the sun gear S1 as a reaction force.

The torque value calculating unit 16 calculates the torque value of torque acting on the sun gear S1 based on output of the strain gauges 24. More specifically, the torque value calculating unit 16 is electrically connected to the strain gauges 24 so as to send electrical signals to the strain gauges 24 and to receive electrical signals from the strain gauges 24 that represent strain on the sun gear S1. The torque value calculating unit 16 has an amplifier (not shown) for amplifying the output signal from the strain gauges 24, and calculates (detects) the torque value acting on the sun gear S1 based on the output voltage of the strain gauges 24 amplified by the amplifier.

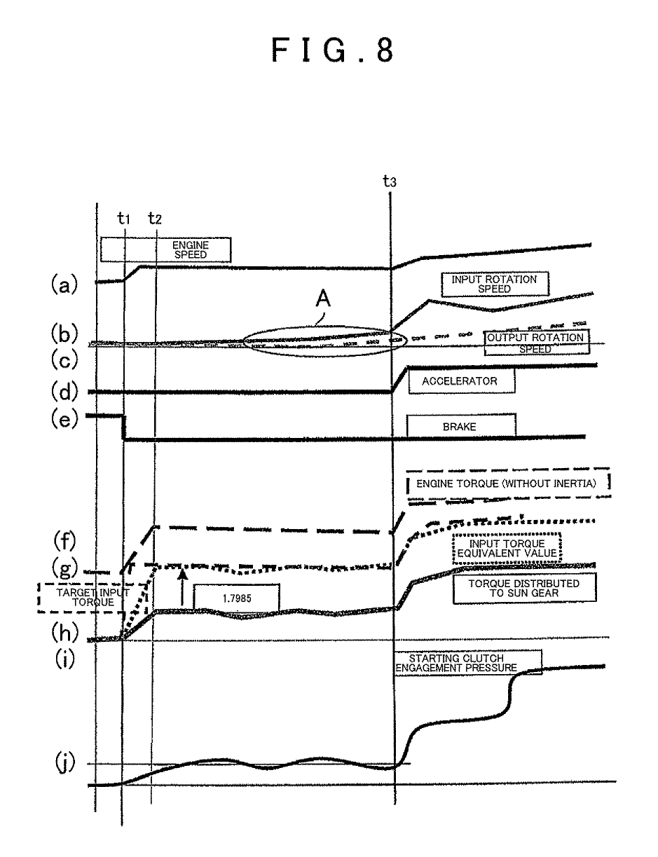

The input equivalent value calculating unit 42 calculates an input torque equivalent value based on the torque value detected by the strain gauges 24 and the torque value calculating unit 16. That is, the input equivalent value calculating unit 42 calculates the input torque equivalent value (refer to (h) in FIG. 8) by multiplying the torque transmitted to the sun gear (refer to (i) in FIG. 8) by, for example, 1.7985 at a shift speed between the first speed (1ST) and the third speed (3RD), by multiplying the torque transmitted to the sun gear by, for example, 6.25 at the fourth speed (4TH), or by multiplying the torque transmitted to the sun gear by, for example, −6.76 at the fifth speed (5TH). However, at sixth speed (6TH), it is impossible to calculate the input torque equivalent value (0) based on the torque value because the rotation of the input shaft 10 is transmitted to the counter gear 11 only through the planetary gear unit PU, without passing through the planetary gear set SP.

The hydraulic pressure control unit 17 issues electrical commands to solenoid valves (not shown) provided in the hydraulic control device 6 to control the hydraulic pressure supplied to the corresponding hydraulic servos for the clutches C-1, C-2, and C-3, and the brakes B-1 and B-2 that serve as friction engagement elements, thereby shifting speeds by switching engagement among these clutches and brakes. The hydraulic pressure control unit 17 serves as a starting control unit that provides creep control (control) by issuing an electrical command to a solenoid valve (not shown) provided in the hydraulic control device 6 to control the hydraulic pressure supplied to the hydraulic servo (for example, 29 in FIG. 6) for the starting clutch 4. In executing the controls described above, the hydraulic pressure control unit 17 controls the hydraulic pressure supplied to each of the hydraulic servos so that the hydraulic pressure is swept at a predetermined sweep gradient for target input torque calculated on the basis of the input torque equivalent value which, in turn, is calculated by the input equivalent value calculating unit 42 based on the torque value detected by the strain gauges 24 and calculated by the torque value calculating unit 16. By changing the input torque target value dependent on accelerator opening and so forth, the hydraulic pressure control unit 17 is able to control, not only the creep force, but also starting.

For creep control, the hydraulic pressure control unit 17 calculates an FF pressure (FF value) for the hydraulic pressure supplied to the hydraulic servo (for example, 29 in FIG. 6) which operates the starting clutch 4, by referring to a FF value map (not shown), and executes FF control. Then, the hydraulic pressure control unit 17 calculates deviation from a target rotational speed difference (deviation=target rotational speed difference−actual rotational speed difference), and if the FF pressure has deviated, executes FB control by calculating a FB pressure (FB value). The learning control unit 28, to be described in detail later, performs a learning correction by using, as a learning value, the hydraulic pressure obtained by adding effect of the FB pressure to the FF pressure, and uses the corrected hydraulic pressure in the next creep control.

In the case of, for example, power-on upshift, the hydraulic pressure control unit 17 refers to the shift map 18 based on a vehicle speed calculated from the rotational speed of the output shaft (not shown) of the automatic speed change mechanism 5 detected by the output shaft rotational speed sensor 23, and also based on the accelerator opening detected by the accelerator opening sensor 25. If the accelerator opening has a predetermined opening value or more and if an upshift point is judged, the hydraulic pressure control unit 17 issues commands to the solenoid valves (not shown) in the hydraulic control device 6 to switch engagement among the friction engagement elements in the automatic speed change mechanism 5 in a manner providing the power-on upshift.

Signals including an engine torque signal are sent from the engine 2 to the control unit 12, and based on the signals from the engine 2, the engine speed detecting unit 19 detects the rotational speed of the engine 2 (hereinafter “engine speed”).

The learning control unit 28 applies the learning correction to the learning value (feedforward value [FF value] as corrected by addition of the previous feedback value [FB value]), obtained when the creep control has been performed by the hydraulic pressure control unit 17, for utilization in the next creep control cycle. Because the learning control unit 28 uses the FF value to which the effect of the previous FB value has been added as a learning value that is provided as an output initial value for the next creep control, variation in the output (creep force) among the control cycles can be reduced so that more precise creep control is provided. Because the present embodiment includes a torque measurement device, i.e. a combination of the strain gauges 24 and the torque value calculating unit 16 with the starting clutch 4, the force of engagement of the starting clutch 4 can be measured as an input torque (actually, as an input torque equivalent value). Therefore, the FB control device, by using the input torque, can control the creep force based on the input torque itself, thereby allowing a reduction in manufacturing cost by, for example, slightly lowering the level of manufacturing quality.

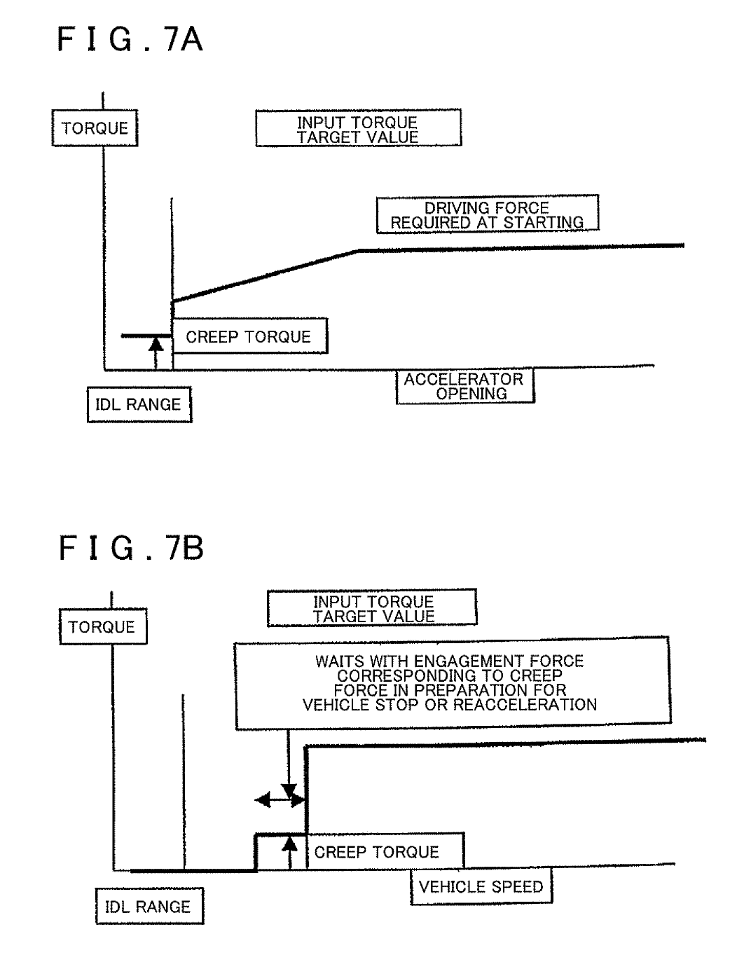

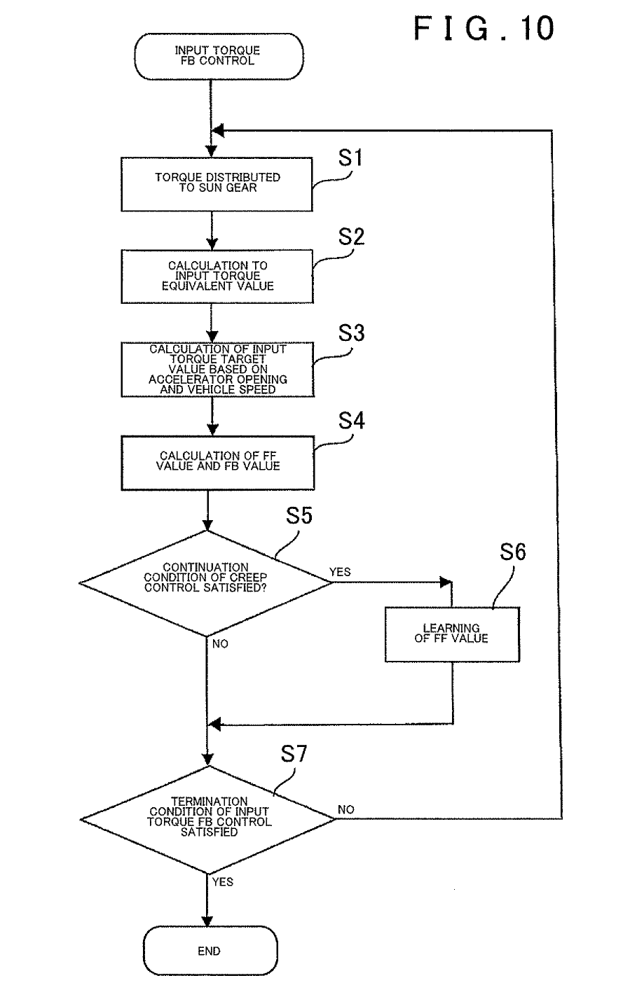

Next, the control by the control apparatus 1 will be described with reference to FIG. 1, the time charts in FIGS. 7 to 9, and the flow chart in FIG. 10.

FIG. 7A shows a state in which a brake is off and the vehicle is accelerating, where the vertical axis represents the torque and the horizontal axis represents the accelerator pedal opening (accelerator opening). FIG. 7A shows transition of a creep force (driving force) from that in the idling range (IDL range), following along the input torque target value, to attainment of a required creep torque (creep force) in accordance with the accelerator opening. FIG. 7B shows a state in which the vehicle brake is on, where the vertical axis represents the torque and the horizontal axis represents the vehicle speed, and in which the control waits with an engagement force corresponding to the creep force in preparation for vehicle stop or reacceleration.

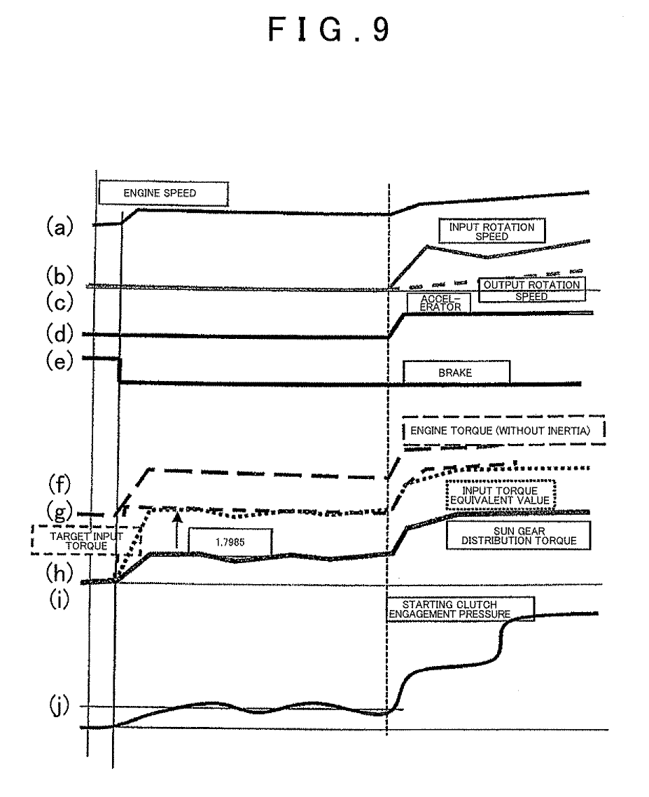

In addition, FIG. 8 shows the case of a creep start on a level road, and FIG. 9 shows the case of running up a hill with a moderate incline. In such a state the creep force is that sufficient for running without acceleration. In FIGS. 8 and 9, the line (a) shows the change in the engine speed; the solid line (b) shows the change in the input rotational speed of the input shaft 10 of the automatic speed change mechanism 5; the dashed line (c) shows the change in the rotational speed (output rotational speed) of the output shaft (not shown) provided on the downstream side of the counter gear 11; (d) shows the change in the signal of the accelerator opening sensor 25; (e) shows the change in the signal of the brake sensor 15; the long dashed line (f) shows the change in an engine torque equivalent value (without inertia); the medium dashed line (g) shows the change in the target input torque; the short dashed line (h) shows the change in the input torque equivalent value that the input equivalent value calculating unit 42 has calculated by multiplying the torque distributed to the sun gear (i) by 1.7985; (i) shows the change in the torque distributed to the sun gear S1; and (j) shows the change in the engagement pressure of the hydraulic servo (for example, 29 in FIG. 6) corresponding to that required to engage the starting clutch 4.

While the vehicle is stationary, the control waits until, for example, the ignition switch (not shown) is turned on and the accelerator pedal is depressed. Then, when the brake pedal is released (after having been depressed when the engine 2 was turned on (refer to time t₁ in FIG. 8), the engine speed slightly increases (refer to (a) in FIG. 8). In this case, because the clutch C-1 is engaged to establish the first speed under control of the hydraulic pressure control unit 17, the engine torque increases in accordance with the increase in the engine speed described above.

Between times t₁ and t₂ in FIG. 8, the hydraulic pressure starts to be supplied to the hydraulic servo for the starting clutch 4 at the time when the brake is released, and distribution of torque to the sun gear has started (S1). That is, because the sun gear S1 receives the reaction force from the pinion P1, strain is imposed on the shaft portion 26 at this time, and that strain is detected by the strain gauges 24. Thus, the torque value calculating unit 16 receives, from the strain gauges 24, an electrical output signal representing the strain on the sun gear S1, and calculates a value for the torque acting on the sun gear S1. Then, the input equivalent value calculating unit 42 calculates the input torque equivalent value based on the torque value determined by the strain gauges 24 and the torque value calculating unit 16.

In addition, based on the input torque equivalent value calculated by the input equivalent value calculating unit 42 (S2), the hydraulic pressure control unit 17 calculates the value for target input torque on the basis of the accelerator opening as detected by the accelerator opening sensor 25 and the vehicle speed, based on the output shaft rotational speed as detected by sensor 23 (S3).

Moreover, in step S4, the hydraulic pressure control unit 17 calculates the FF pressure (FF value) of the hydraulic pressure supplied to the hydraulic servo for the starting clutch 4 by referring to the FF value map and provides the FF control. Furthermore, if the FF pressure deviates from a target value, the hydraulic pressure control unit 17 calculates the FB pressure (FB value) and executes the FB control. Then, in step S5, it is judged whether or not a condition for continuation of creep control is satisfied, and if satisfied, the learning control unit 28 makes the learning correction by using as a learning value the hydraulic pressure obtained by adding the effect of the FB pressure to the FF pressure (S6), and the process proceeds to step S7. On the other hand, if the condition for continuation of creep control is not satisfied in step S5, the process proceeds to step S7 without making a learning correction. Note that the “condition for continuation of creep control” means that the situation in which “maximum vehicle speed is 7 km/h or less,” “engine is idling,” “brake is off,” and “input target torque and detected torque are within ±xx%” is continuously detected for at least a predetermined time period, since the brake off and the vehicle stop zero determinations have been made.

Then, in step S7, it is judged whether or not a condition for termination of input torque FB control is satisfied, and if not satisfied, the routine beginning with step S1 is repeated whereas execution of the routine is terminated if satisfied. Here, the “condition for termination of input torque FB control” means that any one of the conditions “engagement is finished,” “brake is on and vehicle speed is 0,” and “input target torque and measured torque (input torque equivalent value) are 0” is satisfied.

FIG. 9 illustrates travel up a hill with a moderate slope with a creep force just sufficient for running without acceleration. Therefore, the FB control is extremely difficult because the rotational speed corresponding to the timing portion shown as circle A in FIG. 8 is zero.

Subsequently, while the vehicle is running in first speed under control of accelerator pedal operation by a driver, the hydraulic pressure control unit 17 refers to the shift map 18 applying the vehicle speed calculated from the rotational speed of the output shaft of the automatic speed change mechanism 5 detected by the output shaft rotational speed sensor 23, and also the accelerator opening detected by the accelerator opening sensor 25. If the accelerator opening is at least the predetermined opening value and if the upshift point is judged, the hydraulic pressure control unit 17 effects the power-on upshift, for example, from 1st to 2nd speed.

That is, after lapse of a predetermined time beginning when the accelerator opening has been increased by the driver's depression of the accelerator pedal, causing the shift point to cross from the first speed region to the second speed region in the shift map 18, the hydraulic pressure control unit 17 judges a 1st-to-2nd shift. Then, a shift command (flag) is set to the second speed in the hydraulic pressure control unit 17, and the 1st-to-2nd shift control is started. Then, after lapse of a predetermined time for preprocessing, such as by operation of a predetermined shift valve, the shift control is started to control engaging-side hydraulic pressure and disengaging-side hydraulic pressure.

Here, the rotation of the input shaft 10 is transmitted through the starting clutch 4 to the ring gear R1 and from the ring gear R1 to the carrier CR1. Then, with the sun gear S2 locked by engagement of the brake B-1 and the carrier CR2 is disengaged from the one-way clutch F-1, the rotation is transmitted from the carrier CR1 through the sun gear S3, the short pinion PS, and the long pinion PL, then to the ring gear R2, and finally transmitted from the ring gear R2 through the counter gear 11 to the output shaft.

In the present embodiment described above, the strain gauges 24 and the torque value calculating unit 16 detect the torque value acting on the sun gear S1 as a reaction force, the input equivalent value calculating unit 42 calculates the input torque equivalent value based on the detected value for torque, and based on the input torque equivalent value calculated by the input equivalent value calculating unit 42, and the hydraulic pressure control unit (starting control unit) 17 controls the output from the starting clutch 4 by controlling operation of the hydraulic servo (for example, 29 in FIG. 6). Therefore, by measuring the input torque equivalent value for the sun gear S1 and then monitoring the input torque equivalent value as an input target torque, it is possible to provide the precise control (creep control) of the starting clutch 4 while in FB control by appropriately controlling supply of the hydraulic pressure.

The stall torque of a torque converter is stable. If it were to be attempted to set the value equivalent to the creep force of a torque converter with the same degree of accuracy, it would be difficult to control the creep force within a specified range because the effects of automatic transmission oil temperature and so forth must be taken into account. However, according to the present invention, the feedback control (FB) can be effectively based on the actual creep force by using the torque acting on the sun gear S1 as a control parameter.

In addition, in the present embodiment, because the learning control unit 28 applies learning correction to the learning value obtained when the creep control is performed, the corrected value being used in the next executed cycle of creep control, variation in the creep force as between different control cycles can be suppressed to provide more precise creep control.

Moreover, in the present embodiment, the hydraulic pressure control unit 17 supplies the hydraulic pressure based on the command value (FF value, FF value map) for the pressure to be supplied to the hydraulic servo (for example, 29), and the learning control unit 28 calculates the learning value (FB value) that is calculated from the target rotational speed difference and the actual rotational speed difference, and adds the effect of the learning value (FB value) to the command value (FF value). Therefore, it is possible to precisely control the starting clutch 4 while in FB control by appropriate supply of the hydraulic pressure.

In the present embodiment, the fixed gear torque detecting unit is composed of the strain gauges 24 that detect the strain on the sun gear S1 caused by the torque acting from the input shaft 10 side, and the torque value calculating unit 16 calculates the torque value acting on the sun gear S1, based on the detected strain obtained by the strain gauges 24. Therefore, because the strain gauges 24 have a simple structure and comparatively low cost and can be used as strain detecting sensors, detection of the strain between the sun gear S1 and the transmission case 9 can be easily obtained by, for example, directly adhering the strain gauge 24 on the sun gear S1, and it becomes possible to detect the torque value used for the creep control using an extremely simple structure.

Also, in the present embodiment, the automatic speed change mechanism 5 includes the planetary gear set SP, that is capable of outputting rotation at a speed that is decelerated from that of the input shaft 10, the planetary gear unit PU that has the four rotary elements (S2, S3, CR2, and R2) including the ring gear R2 connected to the output shaft (not shown) of the automatic speed change mechanism 5, the two clutches C-1 and C-3 that respectively selectively connect the planetary gear set SP to two rotary elements (S3 and S2) of the planetary gear unit PU, and the clutch C-2 that connects the input shaft 10 to one of the rotary elements (carrier CR2) of the planetary gear unit PU, thereby achieving the six forward speeds. The sun gear S1 is a gear that is constantly held stationary in the planetary gear set SP. Therefore, by using a comparatively simple structure in which merely the strain detecting sensor or the like is attached on the sun gear S1 fixed to the transmission case 9, a change in the input torque can be accurately detected in a direct manner and used as the control parameter in creep control. Of course, the present invention is not limited to an automatic transmission having six forward speeds but is also applicable to automatic transmissions having any number of speeds.

The foregoing embodiment, by way of example, has been described as suitable for use in an FF type vehicle and in an automatic transmission 3 that achieves six forward speeds and one reverse speed. However, the present invention is not limited to such an application, and can also be applied to an automatic transmission suitable for use in a vehicle of the FR (front engine, rear drive) type or of any other type, provided the automatic transmission has a planetary gear set including a gear (for example, a sun gear) constantly fixed to the transmission case.

Also, in the embodiment described above, a stepped automatic speed change mechanism 5 is described as the speed change mechanism. However, the present invention is not limited to this application, and obviously can also be applied to a CVT (continuously variable transmission) used as a speed change mechanism.

The control apparatus for an automatic transmission according to the present invention can be used in an automatic transmission mounted in a passenger vehicle, truck, bus, agricultural machine, or the like, and is particularly suitable for use in an automatic transmission that is equipped with a starting clutch

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A control apparatus for an automatic transmission, comprising:
a speed change mechanism that receives rotation at an input shaft;
a starting clutch that is engaged and disengaged by operation of a hydraulic servo to selectively connect and disconnect a driving source with the input shaft;
a fixed gear, provided in the speed change mechanism, that is fixed to a transmission case and generates a reaction force against the rotation of the input shaft;
a fixed gear torque detecting unit that detects, based on the reaction force, a torque value acting on the fixed gear;
an input equivalent value calculating unit that calculates an input torque equivalent value based on the detected torque value; and
a starting control unit that controls output from the starting clutch by controlling operation of the hydraulic servo, based on the input torque equivalent value calculated by the input equivalent value calculating unit.

2. The control apparatus for an automatic transmission according to claim 1, further comprising:
a learning control unit that applies learning correction to a learning value obtained during each control cycle performed by the starting control unit and wherein the starting control unit uses the corrected learning value to control operation of the hydraulic servo in the next control cycle.

3. The control apparatus for an automatic transmission according to claim 2, wherein
the starting control unit supplies a hydraulic pressure based on a command value for pressure to be supplied to the hydraulic servo, and
the learning control unit calculates a learning value that is calculated from a target rotational speed difference and an actual rotational speed difference, and adds an effect of the learning value to the command value for the hydraulic pressure to be supplied to the hydraulic servo in the next control cycle.

4. The control apparatus for an automatic transmission according to claim 3, wherein the fixed gear torque detecting unit is formed of:
a strain detecting sensor that detects strain on the fixed gear caused by the torque acting from the input shaft side; and
a torque value calculating unit that calculates the torque value acting on the fixed gear, based on the strain detected by the strain detecting sensor.

5. The control apparatus for an automatic transmission according to claim 4, wherein the speed change mechanism includes:
a decelerating planetary gear set that outputs rotation at a speed that is decelerated from the rotational speed of the input shaft;
a planetary gear unit having four rotary elements including an output element connected to an output shaft of the speed change mechanism;
two decelerating clutches that respectively transmit rotation of the decelerating planetary gear set to two of the rotary elements of the planetary gear unit; and
an input clutch that transmits rotation of the input shaft to one of the rotary elements of the planetary gear unit, thereby achieving five or six forward speeds, and
wherein the fixed gear is a gear that is constantly held stationary in the decelerating planetary gear set.

6. The control apparatus for an automatic transmission according to claim 5, wherein:
the decelerating planetary gear set includes a sun gear that is fixed to the transmission case, a ring gear that outputs the decelerated rotation; and a carrier that receives the rotation of the input shaft, and
the fixed gear is the sun gear.

7. The control apparatus for an automatic transmission according to claim 1, wherein
the starting control unit supplies a hydraulic pressure based on a command value for pressure to be supplied to the hydraulic servo, and
the learning control unit calculates a learning value that is calculated from a target rotational speed difference and an actual rotational speed difference, and adds an effect of the learning value to the command value for the hydraulic pressure to be supplied to the hydraulic servo in the next control cycle.

8. The control apparatus for an automatic transmission according to claim 1, wherein the fixed gear torque detecting unit is formed of:
a strain detecting sensor that detects strain on the fixed gear caused by the torque acting from the input shaft side; and
a torque value calculating unit that calculates the torque value acting on the fixed gear, based on the strain detected by the strain detecting sensor.

9. The control apparatus for an automatic transmission according to claim 1, wherein the speed change mechanism includes:
a decelerating planetary gear set that outputs rotation at a speed that is decelerated from the rotational speed of the input shaft;
a planetary gear unit having four rotary elements including an output element connected to an output shaft of the speed change mechanism;
two decelerating clutches that respectively transmit rotation of the decelerating planetary gear set to two of the rotary elements of the planetary gear unit; and
an input clutch that transmits rotation of the input shaft to one of the rotary elements of the planetary gear unit, thereby achieving five or six forward speeds, and
wherein the fixed gear is a gear that is constantly held stationary in the decelerating planetary gear set.
